(19) United States
(12) Patent Application Publication
(10) Pub. No.: US 2026/0112532 A1
(43) Pub. Date: Apr. 23, 2026

(54) MULTILAYER INDUCTOR AND MULTILAYER INDUCTOR ARRAY

(71) Applicant: Murata Manufacturing Co., Ltd., Kyoto-fu (JP)

(72) Inventor: Yuichi OHBA, Nagaokakyo-shi (JP)

(73) Assignee: Murata Manufacturing Co., Ltd., Kyoto-fu (JP)

(21) Appl. No.: 19/418,083

(22) Filed: Dec. 12, 2025

Related U.S. Application Data
(63) Continuation of application No. PCT/JP2024/018328, filed on May 17, 2024.

(30) Foreign Application Priority Data
Sep. 6, 2023 (JP) 2023-144455

(51) Int. Cl. H01F 27/28; H01F 27/24; H01F 27/29

(52) U.S. Cl. CPC H01F 27/2804; H01F 27/24; H01F 27/292; H01F 2027/2809

(57) ABSTRACT

A multilayer inductor and a multilayer inductor array in which the element area is reduced and the direct current superposition characteristics are further improved. A multilayer inductor includes an element body in which magnetic layers are stacked and that has a bottom surface having a rectangular shape, first, second, third and fourth outer electrodes respectively at four corners of the bottom surface of the element body, a first winding portion in which a plurality of conductor layers in the element body are connected in a stacking direction and that has a winding axis in the stacking direction, and a second winding portion that is above the first winding portion in the stacking direction, in which conductor layers in the element body are connected in the stacking direction and that has the winding axis in the stacking direction.

### CROSS-REFERENCE TO RELATED APPLICATIONS

This application claims benefit of priority to International Patent Application No. PCT/JP2024/018328, filed May 17, 2024, and to Japanese Patent Application No. 2023-144455, filed Sep. 6, 2023, the entire contents of each are incorporated herein by reference.

### BACKGROUND

### Technical Field

The present disclosure relates to a multilayer inductor and a multilayer inductor array.

### Background Art

Japanese Unexamined Patent Application Publication No. 2022-922 discloses a multilayer electronic component (multilayer inductor) including an element body including a magnetic layer containing magnetic particles, a coil incorporated in the element body, and outer electrodes that are provided on a bottom surface of the element body and each of which is electrically connected to any one of end portions of the coil. The coil includes a first coil and a second coil, and the outer electrodes include a first outer electrode, a second outer electrode, a third outer electrode, and a fourth outer electrode each of which is connected to any one of end portions of the first coil and the second coil.

### SUMMARY

There is room for further improvement in the multilayer inductor described in Japanese Unexamined Patent Application Publication No. 2022-922 in terms of direct current superposition characteristics. Specifically, according to a schematic diagram (see FIG. 7A) of the multilayer inductor in the related art described in Japanese Unexamined Patent Application Publication No. 2022-922, corner portions Z are provided in an inner peripheral portion of a coil C in top view. In the present specification, the “corner portion” means a position where a plane portion and a curved surface portion intersect each other in an inner peripheral portion of a coil. The “corner portion” may include a position where plane portions intersect each other and a position where curved surface portions intersect each other.

The present inventors have discovered that when a magnetic field analysis is performed on the multilayer inductor in the related art illustrated in FIG. 7A by simulation, as illustrated in FIG. 7B, magnetic saturation occurs in the corner portions Z (in particular, a region R where the corner portions Z concentrate). The present inventors have found that by reducing the magnetic saturation, the direct current superposition characteristics of the multilayer inductor can be further improved.

On the other hand, in the multilayer inductor, as illustrated in FIG. 8, when the coil has a shape (for example, a circular shape, an elliptical shape, or the like), in which a corner portion is not provided in top view, extended wiring lines DW for electrically connecting the coil C to the outer electrodes need to be provided further on an outer side of the coil C in top view, and the element area is increased.

In view of the above points, the present disclosure provides a multilayer inductor and a multilayer inductor array in which the element area is reduced and the direct current superposition characteristics are further improved.

A multilayer inductor of the present disclosure includes an element body in which magnetic layers are stacked in a stacking direction and that has a bottom surface having a rectangular shape, a first outer electrode, a second outer electrode, a third outer electrode, and a fourth outer electrode provided at four corners of the bottom surface of the element body, a first winding portion in which a plurality of conductor layers disposed in the element body are connected in the stacking direction and that has a winding axis in the stacking direction, a second winding portion that is located above the first winding portion in the stacking direction. A plurality of conductor layers disposed in the element body are connected in the stacking direction. The multilayer inductor has a winding axis in the stacking direction. A first through-hole electrically connects one end of the first winding portion to the first outer electrode and extends in the stacking direction, a second through-hole that electrically connects an other end of the first winding portion to the second outer electrode and extends in the stacking direction, a third through-hole that electrically connects one end of the second winding portion to the third outer electrode and extends in the stacking direction, and a fourth through-hole that electrically connects an other end of the second winding portion to the fourth outer electrode and extends in the stacking direction. The first winding portion and the second winding portion have an elliptical shape in top view, and the first winding portion and/or the second winding portion includes an avoiding portion that avoids any one of the first through-hole to the fourth through-hole.

A multilayer inductor array of the present disclosure includes an element body in which magnetic layers are stacked in a stacking direction and that has a bottom surface having a rectangular shape, a first outer electrode, a second outer electrode, a third outer electrode, a fourth outer electrode, a fifth outer electrode, a sixth outer electrode, a seventh outer electrode, and an eighth outer electrode provided along four sides of the bottom surface of the element body. The multilayer inductor array further includes a first winding portion in which a plurality of conductor layers are connected in the stacking direction and has a winding axis in the stacking direction, a second winding portion that is located above the first winding portion in the stacking direction, in which a plurality of conductor layers are connected in the stacking direction, and has a winding axis in the stacking direction, a third winding portion in which a plurality of conductor layers are connected in the stacking direction and has a winding axis in the stacking direction, a fourth winding portion that is located above the third winding portion in the stacking direction, in which a plurality of conductor layers are connected in the stacking direction, and has a winding axis in the stacking direction. A first through-hole electrically connects one end of the first winding portion to the first outer electrode and extends in the stacking direction, a second through-hole electrically connects an other end of the first winding portion to the second outer electrode and extends in the stacking direction, a third through-hole electrically connects one end of the second winding portion to the third outer electrode and extends in the stacking direction, a fourth through-hole electrically connects an other end of the second winding portion to the fourth outer electrode and extends in the stacking direction, a fifth through-hole electrically connects one end of the third winding portion to the fifth outer electrode and extends in the stacking direction, a sixth through-hole electrically connects an other end of the third winding portion to the sixth outer electrode and extends in the stacking direction, a seventh through-hole electrically connects one end of the fourth winding portion to the seventh outer electrode and extends in the stacking direction, and an eighth through-hole electrically connects an other end of the fourth winding portion to the eighth outer electrode and extends in the stacking direction. The third winding portion is disposed in a direction intersecting the stacking direction with respect to the first winding portion, and the fourth winding portion is disposed in the direction intersecting the stacking direction with respect to the second winding portion. The first winding portion to the fourth winding portion have an elliptical shape in top view, the first winding portion or the second winding portion includes a first avoiding portion that avoids any one of the first through-hole to the fourth through-hole, and the third winding portion or the fourth winding portion includes a second avoiding portion that avoids any one of the fifth through-hole to the eighth through-hole.

According to the present disclosure, a multilayer inductor in which the element area is reduced and the direct current superposition characteristics are further improved can be provided. Specifically, since the first winding portion and the second winding portion have an elliptical shape in top view, compared to the multilayer inductor described in Japanese Unexamined Patent Application Publication No. 2022-922, the avoiding portion is reduced, and the number of the corner portions of the multilayer inductor is reduced, thereby being able to reduce magnetic saturation. Therefore, the direct current superposition characteristics of the multilayer inductor can be further improved. In addition, since the first winding portion and/or the second winding portion is provided with an avoiding portion that avoids any one of the first through-hole to the fourth through-hole, the element area can be further reduced compared to a multilayer inductor not provided with the avoiding portion and including a coil having a perfectly elliptical shape.

### BRIEF DESCRIPTION OF THE DRAWINGS

FIG. 1 is a perspective view schematically illustrating an example of a multilayer inductor of the present disclosure;

FIG. 2 is a perspective view schematically illustrating an example of a first coil and a second coil of the present disclosure;

FIG. 3 is an exploded perspective view schematically illustrating an example of an internal structure of the multilayer inductor of the present disclosure;

FIG. 4 is a perspective view schematically illustrating an example of a multilayer inductor array of the present disclosure;

FIG. 5 is a perspective view schematically illustrating a modification of the multilayer inductor array of the present disclosure;

FIG. 6 is an explanatory view of a magnetic field analysis result by simulation with respect to the multilayer inductor of the present disclosure;

FIG. 7A is a perspective view schematically illustrating a comparative example of the multilayer inductor;

FIG. 7B is an explanatory view of a magnetic field analysis result by simulation with respect to a multilayer inductor in the related art;

FIG. 8 is a plan view of an inductor in which a coil is not provided with a corner portion; and

FIG. 9 is a graph illustrating results of direct current superposition characteristics.

### DETAILED DESCRIPTION

Hereinafter, a multilayer inductor of the present disclosure will be described. The present disclosure is not limited to the configurations below, and appropriate modifications can be made without departing from the spirit of the present disclosure. Combinations of two or more individual preferred configurations described below are also included in the present disclosure.

The multilayer inductor of the present disclosure is used as, for example, a choke coil of a direct current-direct current (DC-DC) converter. The multilayer inductor of the present disclosure can be appropriately used for a use other than a choke coil.

In the present specification, terms indicating relations among elements (for example, “parallel”, “orthogonal”, and the like) and terms indicating shapes of the elements not only mean strict and literal aspects but also mean virtually equivalent ranges such as ranges covering tolerances of several percent. In the present specification, a direction in which magnetic material layers and coil conductors that constitute an element body are stacked is referred to as a “stacking direction.” The drawings to be referred to below are schematic, and thus dimensions, aspect ratios, and the like may be different from those of an actual product.

### Multilayer Inductor

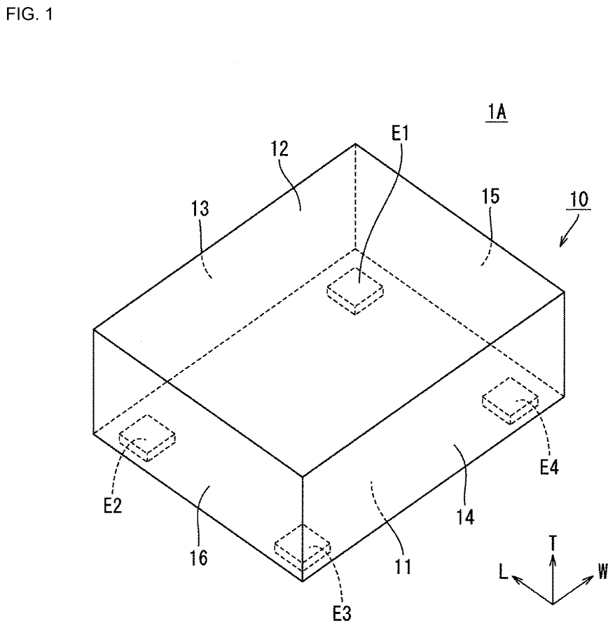

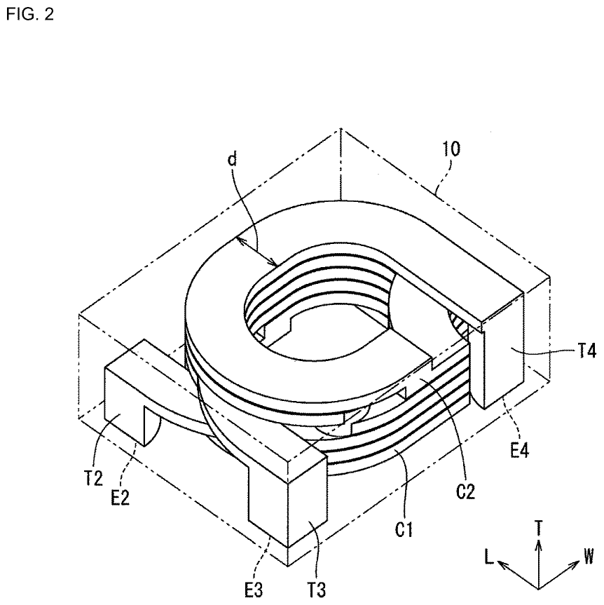

First, an embodiment of the multilayer inductor of the present disclosure will be described with reference to FIGS. 1 to 3. FIG. 1 is a perspective view schematically illustrating an example of the multilayer inductor of the present disclosure, and FIG. 2 is a perspective view schematically illustrating an example of a first coil and a second coil of the present disclosure.

A multilayer inductor 1A illustrated in FIGS. 1 and 2 includes an element body 10, a first outer electrode E1, a second outer electrode E2, a third outer electrode E3, a fourth outer electrode E4, a first coil C1, a second coil C2, a first through-hole T1, a second through-hole T2, a third through-hole T3, and a fourth through-hole T4. Each constituent element will be described below.

### —Element Body—

The element body 10 is, for example, a hexahedron shape having six faces. For example, the element body 10 may have a rectangular parallelepiped shape or a substantially rectangular parallelepiped shape. The element body 10 may have corner portions and ridge portions that are rounded. Each corner portion is a portion where three faces of the element body 10 meet, and each ridge portion is a portion where two faces of the element body 10 meet.

In FIG. 1, a length direction, a width direction, and a height direction in the multilayer inductor 1A and the element body 10 are indicated as an L direction, a W direction, and a T direction, respectively. The length direction L, the width direction W, and the height direction T are orthogonal to each other.

The element body 10 illustrated in FIG. 1 includes a first main surface 11 and a second main surface 12 facing in the height direction T, a first end surface 13 and a second end surface 14 facing in the length direction L, and a first side surface 15 and a second side surface 16 facing in the width direction W. In the example illustrated in FIG. 1, the first outer electrode E1, the second outer electrode E2, the third outer electrode E3, and the fourth outer electrode E4 are formed at respective four corners of the first main surface 11 of the element body 10, and the first main surface 11 corresponds to a mounting surface (bottom surface) of the element body 10.

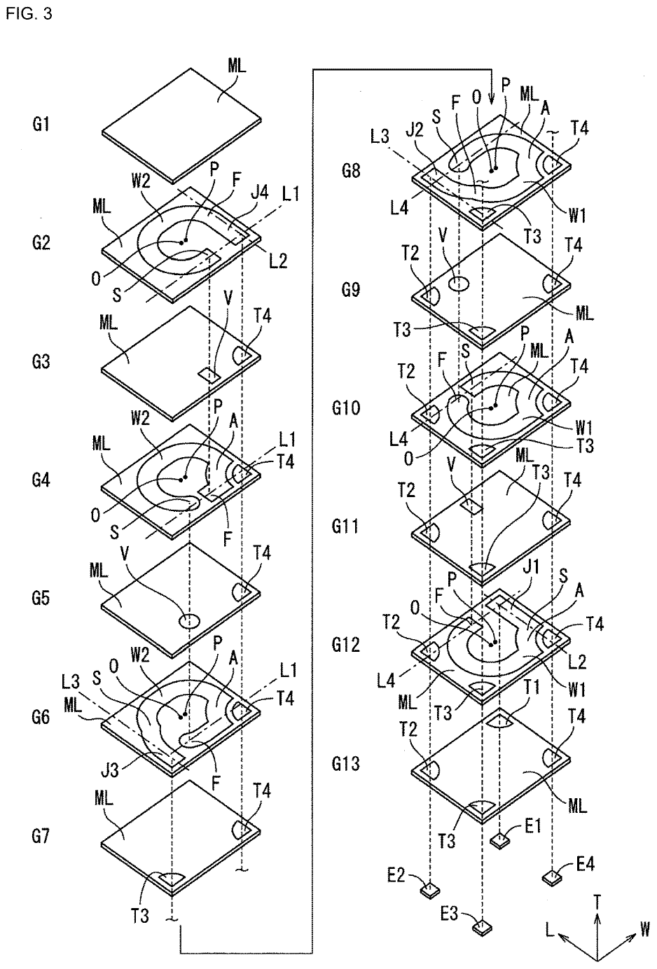

FIG. 3 is an exploded perspective view schematically illustrating an example of an internal structure of the multilayer inductor of the present disclosure. As illustrated in FIG. 3, the element body 10 is configured by stacking a plurality of magnetic material layers ML in the height direction. Inside the element body 10, the first coil C1 having a first winding portion W1 and the second coil C2 having a second winding portion W2 described later may be included. In the present embodiment, as illustrated in FIG. 3, the element body 10 is configured by stacking stacking groups G1 to G13 and forming the first outer electrode E1 to the fourth outer electrode E4 under the stacking group G13. Boundaries of the respective layers of the multilayer structure included in the element body 10 may disappear. In addition, the respective stacking groups G1 to G13 may be configured by stacking a plurality of layers of the same patterns.

(Stacking Group G1) The stacking group G1 includes a corresponding one of the magnetic material layers ML and may constitute the second main surface 12 of the element body 10.

### (Stacking Group G2)

The stacking group G2 includes a corresponding one of the magnetic material layers ML, the second winding portion W2 configured by winding a conductor layer, and the fourth through-hole T4 (not illustrated). In addition, the stacking group G2 may include a fourth connecting portion J4 that connects the second winding portion W2 to the fourth through-hole T4, and a via-hole (not illustrated) connected to the second winding portion W2 of the stacking group G4.

The second winding portion W2 of the stacking group G2 has an elliptical shape in top view. In the present specification, the “elliptical shape” means a shape not having a corner portion in an inner peripheral portion of the winding portion except a place avoided by an avoiding portion. Specifically, an egg shape, an oval shape, or an elliptical shape (an oval track shape) in which a curved surface portion and a straight portion smoothly continue. In addition, a winding axis P of the second winding portion W2 may be deviated from a center O of the element body 10 in top view. In other words, the winding axis P of the coil and the center O of the element body 10 do not have to coincide with each other.

When an end portion of the second winding portion W2 of the stacking group G2 corresponding to a winding start is one end S, and an end portion corresponding to a winding end is an other end F, the one end S may be provided on a straight line L1 connecting the fourth outer electrode E4 and the third outer electrode E3 in top see-through view. The one end S may be connected to a via-hole V of the stacking group G3. In addition, the other end F may be provided on a straight line L2 connecting the fourth outer electrode E4 and the first outer electrode E1 in top see-through view. With a configuration having such a winding start and a winding end, the inner diameter of the second winding portion W2 can be made as large as possible, and the characteristics of the inductor can be improved.

The fourth through-hole (not illustrated) of the stacking group G2 may be electrically connected to the other end F of the second winding portion W2. In the present specification, “electrically connected” is not limited to a direct connection between a winding portion and a through-hole and is intended to allow interposition of another element such as an interposing item (for example, a connecting portion). The fourth through-hole T4 may be disposed above the fourth outer electrode E4.

The fourth connecting portion J4 of the stacking group G2 may be interposed between the second winding portion W2 and the fourth through-hole (not illustrated). The shape of the fourth connecting portion J4 may be linear in top view. With such a shape formed, the inner diameter of the second winding portion W2 can be made as large as possible, and the characteristics of the inductor can be improved.

### (Stacking Group G3)

The stacking group G3 includes a corresponding one of the magnetic material layers ML, the via-hole V that connects parts of the second winding portion W2 adjacent to each other in the stacking direction, and the fourth through-hole T4.

The via-hole V of the stacking group G3 may be disposed at a position connected to the one end S of the second winding portion W2 of the stacking group G2 described above. The via-hole V of the stacking group G3 may be disposed adjacent to the fourth through-hole T4 in top view at such a distance that electric insulation can be secured.

The fourth through-hole T4 of the stacking group G3 may connect parts of the fourth through-hole T4 of the stacking groups G2 and G4 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to an outer edge of an avoiding portion A described later in top see-through view. That is, the shape of the fourth through-hole T4 may be a shape in which an interval between the fourth through-hole T4 and the avoiding portion A is kept constant.

### (Stacking Group G4)

The stacking group G4 includes a corresponding one of the magnetic material layers ML, the second winding portion W2 configured by winding a conductor layer, and the fourth through-hole T4. Moreover, the stacking group G4 may include a via-hole (not illustrated) connected to the second winding portion W2 of the stacking group G6.

The second winding portion W2 of the stacking group G4 has an elliptical shape in top view. In addition, in top see-through view, at least a part of the second winding portion W2 of the stacking group G4 may overlap with the second winding portion W2 of the stacking group G2. In addition, the winding axis P of the second winding portion W2 may be deviated from the center O of the element body 10 in top view.

When an end portion of the second winding portion W2 of the stacking group G4 corresponding to a winding start is one end S, and an end portion corresponding to a winding end is an other end F, the one end S and the other end F may be provided on the straight line L1 connecting the fourth outer electrode E4 and the third outer electrode E3 in top see-through view. Moreover, the one end S may be disposed on a side close to the third outer electrode E3 compared to the other end F. The one end S may be connected to the via-hole V of the stacking group G5. In addition, the other end F may be connected to the via-hole V of the stacking group G3. With a configuration having such a winding start and a winding end, the inner diameter of the second winding portion W2 can be made as large as possible, and the characteristics of the inductor can be improved.

The second winding portion W2 of the stacking group G4 may include the avoiding portion A that avoids the fourth through-hole T4. As a preferred aspect of the avoiding portion A, the avoiding portion A may have a shape projecting further toward an inner diameter side of the coil than the fourth through-hole T4 (a shape projecting toward the inside of the coil) in top view. In addition, the avoiding portion A may be provided at one location in the second winding portion W2. By avoiding the fourth through-hole T4 by the avoiding portion A, the element area can be reduced compared to an aspect in which the avoiding portion is not provided.

The fourth through-hole T4 of the stacking group G4 may connect parts of the fourth through-hole T4 of the stacking groups G3 and G5 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G5)

The stacking group G5 includes a corresponding one of the magnetic material layers ML, a via-hole V that connects parts of the second winding portion W2 adjacent to each other in the stacking direction, and the fourth through-hole T4.

The via-hole V of the stacking group G5 may be disposed at a position connected to the one end S of the second winding portion W2 of the stacking group G4 described above. The via-hole V of the stacking group G5 may be disposed adjacent to the fourth through-hole T4 in top view at such a distance that electric insulation can be secured.

The fourth through-hole T4 of the stacking group G5 may connect parts of the fourth through-hole T4 of the stacking groups G4 and G6 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G6)

The stacking group G6 includes a corresponding one of the magnetic material layers ML, the second winding portion W2 configured by winding a conductor layer, a third through-hole (not illustrated), and the fourth through-hole T4. Moreover, the stacking group G6 may include a third connecting portion J3 that connects the second winding portion W2 to the third through-hole T3.

The second winding portion W2 of the stacking group G6 has an elliptical shape in top view. In addition, in top see-through view, at least a part of the second winding portion W2 of the stacking group G6 may overlap with the second winding portion W2 of the stacking group G4. In addition, the winding axis P of the second winding portion W2 may be deviated from the center O of the element body 10 in top view.

When an end portion of the second winding portion W2 of the stacking group G6 corresponding to a winding start is one end S, and an end portion corresponding to a winding end is an other end F, the one end S may be provided on a straight line L3 connecting the third outer electrode E3 and the second outer electrode E2 or on an inner side of the straight line L3 in top see-through view. Moreover, the other end F may be disposed on the straight line L1 connecting the fourth outer electrode E4 and the third outer electrode E3 in top see-through view. The other end F may be connected to the via-hole V of the stacking group G5. With a configuration having such a winding start and a winding end, the inner diameter of the second winding portion W2 can be made as large as possible, and the characteristics of the inductor can be improved.

The second winding portion W2 of the stacking group G6 may include the avoiding portion A that avoids the fourth through-hole T4. As a preferred aspect of the avoiding portion A, the avoiding portion A may have a shape projecting further toward an inner diameter side of the coil than the fourth through-hole T4 in top view. In addition, the avoiding portion A may be provided at one location in the second winding portion W2. By avoiding the fourth through-hole T4 by the avoiding portion A, the element area can be reduced compared to an aspect in which the avoiding portion is not provided.

The third through-hole (not illustrated) of the stacking group G6 is electrically connected to the one end S of the second winding portion W2. The third through-hole may be disposed above the third outer electrode E3.

The third connecting portion J3 of the stacking group G6 may be interposed between the second winding portion W2 and the third through-hole (not illustrated). The shape of the third connecting portion J3 in top view may be curved. With such a shape formed, the second winding portion W2 and the third through-hole can be appropriately connected.

A curvature of the third connecting portion J3 of the stacking group G6 may be smaller than a curvature of the second winding portion W2 having an elliptical shape. In other words, the third connecting portion J3 may be curved more gently than the second winding portion W2. By setting the curvature of the third connecting portion J3 in this manner, the inner diameter of the second winding portion W2 can be made as large as possible, and the characteristics of the inductor can be improved.

The fourth through-hole T4 of the stacking group G6 may connect parts of the fourth through-hole T4 of the stacking groups G5 and G7 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G7)

The stacking group G7 includes a corresponding one of the magnetic material layers ML, the third through-hole T3, and the fourth through-hole T4.

The third through-hole T3 of the stacking group G7 may connect parts of the third through-hole T3 of the stacking groups G6 and G8 adjacent to each other in the stacking direction so as to be electrically conducted to the third outer electrode E3. Therefore, the third through-hole T3 may be disposed above the third outer electrode E3.

The fourth through-hole T4 of the stacking group G7 may connect parts of the fourth through-hole T4 of the stacking groups G6 and G8 adjacent to each other in the stacking direction so as to be electrically conducted to the fourth outer electrode E4. Therefore, the fourth through-hole T4 may be disposed above the fourth outer electrode E4.

### (Stacking Group G8)

The stacking group G8 includes a corresponding one of the magnetic material layers ML, the first winding portion W1 configured by winding a conductor layer, a second through-hole (not illustrated), the third through-hole T3, and the fourth through-hole T4. In addition, the stacking group G8 may include a second connecting portion J2 that connects the first winding portion W1 to the second through-hole, and a via-hole (not illustrated) connected to the first winding portion W1 of the stacking group G10.

The first winding portion W1 of the stacking group G8 has an elliptical shape in top view. In addition, in top see-through view, at least a part of the first winding portion W1 of the stacking group G8 may overlap with the first winding portion W1 of the stacking group G10. In addition, the winding axis P of the first winding portion W1 may be deviated from the center O of the element body 10 in top view.

When an end portion of the first winding portion W1 of the stacking group G8 corresponding to a winding start is one end S, and an end portion corresponding to a winding end is an other end F, the one end S may be provided on a straight line L4 connecting the second outer electrode E2 and the first outer electrode E1 in top see-through view. The one end S may be connected to the via-hole V of the stacking group G9. The other end F may be provided on the straight line L3 connecting the third outer electrode E3 and the second outer electrode E2 or on an inner side of the straight line L3 in top see-through view. With a configuration having such a winding start and a winding end, the inner diameter of the first winding portion W1 can be made as large as possible, and the characteristics of the inductor can be improved.

The first winding portion W1 of the stacking group G8 may include the avoiding portion A that avoids the fourth through-hole T4. The avoiding portion A may be provided at one location in the first winding portion W1. As a preferred aspect of the avoiding portion A, the avoiding portion A may have a shape projecting further toward an inner diameter side of the coil than the fourth through-hole T4 in top view. By avoiding the fourth through-hole T4 by the avoiding portion A, the element area can be reduced compared to an aspect in which the avoiding portion is not provided.

The second through-hole (not illustrated) of the stacking group G8 is electrically connected to the other end F of the first winding portion W1. The second through-hole T2 may be disposed above the second outer electrode E2.

The second connecting portion J2 of the stacking group G8 may be interposed between the first winding portion W1 and the second through-hole (not illustrated). The shape of the second connecting portion J2 in top view may be curved. With such a shape formed, the first winding portion W1 and the second through-hole can be appropriately connected.

A curvature of the second connecting portion J2 of the stacking group G8 may be smaller than a curvature of the first winding portion W1 having an elliptical shape. In other words, the second connecting portion J2 may be curved more gently than the first winding portion W1. By setting the curvature of the second connecting portion J2 in this manner, the inner diameter of the first winding portion W1 can be made as large as possible, and the characteristics of the inductor can be improved.

The third through-hole T3 of the stacking group G8 may connect parts of the third through-hole T3 of the stacking groups G7 and G9 adjacent to each other in the stacking direction so as to be electrically conducted to the third outer electrode E3. Therefore, the third through-hole T3 may be disposed above the third outer electrode E3.

The fourth through-hole T4 of the stacking group G8 may connect parts of the fourth through-hole T4 of the stacking groups G7 and G9 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G9)

The stacking group G9 may include a corresponding one of the magnetic material layers ML, a via-hole V that connects parts of the first winding portion W1 adjacent to each other in the stacking direction, the second through-hole T2, the third through-hole T3, and the fourth through-hole T4.

The via-hole V of the stacking group G9 may be disposed at a position connected to the one end S of the first winding portion W1 of the stacking group G8 described above. The via-hole V of the stacking group G9 may be disposed adjacent to the second through-hole T2 in top view at such a distance that electric insulation can be secured.

The second through-hole T2 of the stacking group G9 may connect parts of the second through-hole T2 of the stacking groups G8 and G10 adjacent to each other in the stacking direction so as to be electrically conducted to the second outer electrode E2. Therefore, the second through-hole T2 may be disposed above the second outer electrode E2.

The third through-hole T3 of the stacking group G9 may connect parts of the third through-hole T3 of the stacking groups G8 and G10 adjacent to each other in the stacking direction so as to be electrically conducted to the third outer electrode E3. Therefore, the third through-hole T3 may be disposed above the third outer electrode E3.

The fourth through-hole T4 of the stacking group G9 may connect parts of the fourth through-hole T4 of the stacking groups G8 and G10 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G10)

The stacking group G10 may include a corresponding one of the magnetic material layers ML, the first winding portion W1 configured by winding a conductor layer, the second through-hole T2, the third through-hole T3, and the fourth through-hole T4. Moreover, the stacking group G10 may include a via-hole (not illustrated) connected to the first winding portion W1 of the stacking group G12.

The first winding portion W1 of the stacking group G10 has an elliptical shape in top view. In addition, in top see-through view, at least a part of the first winding portion W1 of the stacking group G10 may overlap with the first winding portion W1 of the stacking group G8. In addition, the winding axis P of the first winding portion W1 may be deviated from the center O of the element body 10 in top view.

When an end portion of the first winding portion W1 of the stacking group G10 corresponding to a winding start is one end S, and an end portion corresponding to a winding end is an other end F, the one end S and the other end F may be provided on the straight line L4 connecting the second outer electrode E2 and the first outer electrode E1 in top see-through view. Moreover, the one end S may be disposed on a side close to the first outer electrode E1 compared to the other end F. The one end S may be connected to the via-hole V of the stacking group G11. The other end F may be connected to the via-hole V of the stacking group G9. With a configuration having such a winding start and a winding end, the inner diameter of the first winding portion W1 can be made as large as possible, and the characteristics of the inductor can be improved.

The first winding portion W1 of the stacking group G10 may include the avoiding portion A that avoids the fourth through-hole T4. As a preferred aspect of the avoiding portion A, the avoiding portion A may have a shape projecting further toward an inner diameter side of the coil than the fourth through-hole T4 in top view. The avoiding portion A may be provided at one location in the first winding portion W1. By avoiding the fourth through-hole T4 by the avoiding portion A, the element area can be reduced compared to an aspect in which the avoiding portion is not provided.

The second through-hole T2 of the stacking group G10 may connect parts of the second through-hole T2 of the stacking groups G9 and G11 adjacent to each other in the stacking direction so as to be electrically conducted to the second outer electrode E2. Therefore, the second through-hole T2 may be disposed above the second outer electrode E2.

The third through-hole T3 of the stacking group G10 may connect parts of the third through-hole T3 of the stacking groups G9 and G11 adjacent to each other in the stacking direction so as to be electrically conducted to the third outer electrode E3. Therefore, the third through-hole T3 may be disposed above the third outer electrode E3.

The fourth through-hole T4 of the stacking group G10 may connect parts of the fourth through-hole T4 of the stacking groups G9 and G11 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G11)

The stacking group G11 may include a corresponding one of the magnetic material layers ML, a via-hole V that connects parts of the first winding portion W1 adjacent to each other in the stacking direction, the second through-hole T2, the third through-hole T3, and the fourth through-hole T4.

The via-hole V of the stacking group G11 may be disposed at a position connected to the one end S of the first winding portion W1 of the stacking group G10 described above. The via-hole V of the stacking group G11 may be disposed adjacent to the second through-hole T2 in top view at such a distance that electric insulation can be secured.

The second through-hole T2 of the stacking group G11 may connect parts of the second through-hole T2 of the stacking groups G10 and G12 adjacent to each other in the stacking direction so as to be electrically conducted to the second outer electrode E2. Therefore, the second through-hole T2 may be disposed above the second outer electrode E2.

The third through-hole T3 of the stacking group G11 may connect parts of the third through-hole T3 of the stacking groups G10 and G12 adjacent to each other in the stacking direction so as to be electrically conducted to the third outer electrode E3. Therefore, the third through-hole T3 may be disposed above the third outer electrode E3.

The fourth through-hole T4 of the stacking group G11 may connect parts of the fourth through-hole T4 of the stacking groups G10 and G12 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G12)

The stacking group G12 may include a corresponding one of the magnetic material layers ML, the first winding portion W1 configured by winding a conductor layer, a first through-hole (not illustrated), the second through-hole T2, the third through-hole T3, and the fourth through-hole T4. Moreover, the stacking group G12 may include a first connecting portion J1 that connects the first winding portion W1 to the first through-hole.

The first winding portion W1 of the stacking group G12 has an elliptical shape in top view. In addition, in top see-through view, at least a part of the first winding portion W1 of the stacking group G12 may overlap with the first winding portion W1 of the stacking group G10. In addition, the winding axis P of the first winding portion W1 may be deviated from the center O of the element body 10 in top view.

When an end portion of the first winding portion W1 of the stacking group G12 corresponding to a winding start is one end S, and an end portion corresponding to a winding end is an other end F, the one end S may be provided on the straight line L2 connecting the fourth outer electrode E4 and the first outer electrode E1 in top see-through view. The other end F may be disposed on the straight line L4 connecting the second outer electrode E2 and the first outer electrode E1 in top see-through view. Moreover, the other end F may be connected to the via-hole V of the stacking group G11. With a configuration having such a winding start and a winding end, the inner diameter of the first winding portion W1 can be made as large as possible, and the characteristics of the inductor can be improved.

The first winding portion W1 of the stacking group G12 may include the avoiding portion A that avoids the fourth through-hole T4. The avoiding portion A may be provided at one location in the first winding portion W1. As a preferred aspect of the avoiding portion A, the avoiding portion A may have a shape projecting further toward an inner diameter side of the coil than the fourth through-hole T4 in top view. By avoiding the fourth through-hole T4 by the avoiding portion A, the element area can be reduced compared to an aspect in which the avoiding portion is not provided.

The first through-hole (not illustrated) of the stacking group G12 is electrically connected to the one end S of the first winding portion W1. The first through-hole T1 may be disposed above the first outer electrode E1.

The first connecting portion J1 of the stacking group G12 may be interposed between the first winding portion W1 and the first through-hole (not illustrated). The shape of the first connecting portion J1 may be linear in top view. With such a shape formed, the inner diameter of the first winding portion W1 can be made as large as possible, and the characteristics of the inductor can be improved.

The second through-hole T2 of the stacking group G12 may connect parts of the second through-hole T2 of the stacking groups G11 and G13 adjacent to each other in the stacking direction so as to be electrically conducted to the second outer electrode E2. Therefore, the second through-hole T2 may be disposed above the second outer electrode E2.

The third through-hole T3 of the stacking group G12 may connect parts of the third through-hole T3 of the stacking groups G11 and G13 adjacent to each other in the stacking direction so as to be electrically conducted to the third outer electrode E3. Therefore, the third through-hole T3 may be disposed above the third outer electrode E3.

The fourth through-hole T4 of the stacking group G12 may connect parts of the fourth through-hole T4 of the stacking groups G11 and G13 adjacent to each other in the stacking direction so as to be electrically conducted to the fourth outer electrode E4. Therefore, the fourth through-hole T4 may be disposed above the fourth outer electrode E4. In addition, the fourth through-hole T4 may have a shape corresponding to the outer edge of the avoiding portion A in top see-through view.

### (Stacking Group G13)

The stacking group G13 may include a corresponding one of the magnetic material layers ML, the first through-hole T1, the second through-hole T2, the third through-hole T3, and the fourth through-hole T4. The areas of parts of the first through-hole T1 to parts of the fourth through-hole T4 of the stacking groups G1 to G13 in top view may be substantially the same.

As a preferred aspect of the stacking group, an additional stacking group may be provided below the stacking group G13. The additional stacking group may include a first through-hole to a fourth through-hole whose areas in top view are larger than those of parts of the first through-hole T1 to parts of the fourth through-hole T4 of the stacking groups G1 to G13. By making the plane areas of the first through-hole T1 to the fourth through-hole T4 of the additional stacking group larger than those of the first outer electrode E1 to the fourth outer electrode E4, even when shrinkage by firing occurs, if the first outer electrode E1 to the fourth outer electrode E4 are formed after firing, the outer electrodes can be located at predetermined positions. Since the additional stacking group is provided for reducing a positional deviation, the thickness of the additional stacking group may be smaller than the thicknesses of the stacking groups G1 to G13.

The thickness of each of the first winding portion W1 and/or the second winding portion W2 in each stacking group may be the same. In addition, the thickness of each of the first through-hole T1 to the fourth through-hole T4 and/or the via-hole V may be smaller than the thickness of each of the first winding portion W1 and/or the second winding portion W2 in each stacking group. The thickness of the via-hole V may be different in each layer. For example, the via-holes V between the parts of the second winding portion W2 (the stacking groups G3 and G5) and between the parts of the first winding portion W1 (the stacking groups G9 and G11) may be thinner than a space between the first winding portion W1 and the second winding portion W2 (the stacking group G7).

The first winding portion W1 and/or the second winding portion W2, the first through-hole T1 to the fourth through-hole T4, and the via-hole V may be metal conductors made of, for example, Ag and/or Cu and may be made using the same type or different types of materials. The first winding portion W1 and/or the second winding portion W2, the first through-hole T1 to the fourth through-hole T4 and/or the via-hole V may be formed by, for example, after applying a conductive paste to the above-described magnetic material layer ML, printing a magnetic material layer ML outside of the conductive paste.

As described above, when the element body 10 has a multilayer structure including the stacking groups G1 to G13, the degree of freedom in designing the multilayer inductor 1A is further improved. For example, when the multilayer inductor 1A in which the element body 10 includes the bottom surface (the first main surface 11) including the first outer electrode E1, the second outer electrode E2, the third outer electrode E3, and the fourth outer electrode E4 is manufactured, the first winding portion W1 and the second winding portion W2 can be easily extended to the bottom surface side. The multilayer structure including the above-described stacking groups G1 to G13 may be formed by repeatedly applying, from the second main surface 12 side or the first main surface side 11 of the element body 10, a material constituting the magnetic material layer ML, a material constituting the first winding portion W1 or the second winding portion W2, and a material constituting the through-hole and/or the via-hole by, for example, screen printing or the like until a desired thickness of the via-hole is obtained sequentially, or may be formed by a sputtering method, an ink jet method, or other known methods.

Further additional elements related to the element body 10 will be described. The magnetic material layer ML may include metal magnetic particles composed of a magnetic material. The metal magnetic particles may contain Fe and/or Si. More specifically, the metal magnetic particles may be Fe particles or Fe alloy particles. As an Fe alloy, an Fe—Si-based alloy, an Fe—Si—Cr-based alloy, an Fe—Si—Al-based alloy, an Fe—Si—B—P—Cu—C-based alloy, an Fe—Si—B—Nb—Cu-based alloy or the like may be used. In addition, the metal magnetic particles may contain impurities such as Cr, Mn, Cu, Ni, P, S, Co, and the like that are not intended during manufacturing. In addition, the metal magnetic particles may be contained in a magnetic paste. Therefore, the metal magnetic particles may contain an element (for example, Cr, Al, Li, and Zn) more susceptible to oxidization than Fe that is added when the magnetic paste is produced.

A surface of each of the above-described metal magnetic particles may be covered with an insulating film (not illustrated). When the surface of the metal magnetic particle is covered with the insulating film, the insulating property between the metal magnetic particles is enhanced. As a method for forming the insulating film on the surface of the metal magnetic particle, a sol-gel method, a mechanochemical method, or the like can be used. The material constituting the insulating film may be an oxide of P, Si, and the like, zinc phosphate, or manganese phosphate. In addition, the insulating film may be an oxide film formed by oxidizing the surface of the metal magnetic particle. The thickness of the insulating film is preferably equal to or more than 1 nm and equal to or less than 50 nm (i.e., from 1 nm to 50 nm), more preferably equal to or more than 1 nm and equal to or less than 30 nm (i.e., from 1 nm to 30 nm), and still more preferably equal to or more than 1 nm and equal to or less than 20 nm (i.e., from 1 nm to 20 nm). For example, a photograph of a cross section obtained by polishing a sample of the inductor is taken with a scanning electron microscope (SEM), and from the obtained SEM photograph, the thickness of the insulating film covering the surface of the metal magnetic particle can be measured.

An average particle diameter of the metal magnetic particles in the magnetic material layer ML is preferably equal to or more than 1 μm and equal to or less than 30 μm (i.e., from 1 μm to 30 μm), more preferably equal to or more than 1 μm and equal to or less than 20 μm (i.e., from 1 μm to 20 μm), and still more preferably equal to or more than 1 μm and equal to or less than 10 μm (i.e., from 1 μm to 10 μm). The average particle diameter of metal magnetic particles in a magnetic layer can be measured by the procedures described below. A sample cross section is obtained by cutting a sample of the inductor. Specifically, a sample cross section is obtained by cutting the element body such that the cross section passes through the central portion of the element body and is orthogonal to the mounting surface and an end surface of the element body. In the obtained cross section, regions (for example, 130 μm×100 μm) at a plurality of locations (for example, five locations) are imaged with the SEM, the obtained SEM images are analyzed using image analysis software (for example, image analysis software WinROOF2021 (manufactured by Mitani Corporation)) so as to obtain circle equivalent diameters of the metal magnetic 01particles. The average value of the obtained circle equivalent diameters is the average particle diameter of the metal magnetic particles.

When the element body 10 is formed, heat treatment is performed. In this case, the metal magnetic particle contained in the element body 10 has an oxide film on the surface. The oxide film is derived from the metal magnetic particle and is formed by heat treatment. In the element body 10, the metal magnetic particles adjacent to each other may be bonded to each other with the oxide film interposed therebetween.

In order to further improve the element body strength of the element body 10, a resin material may be impregnated after firing of the element body 10. As a resin that increases the element body strength, for example, an epoxy resin, a phenolic resin and/or a silicone resin may be used.

### —Outer Electrode—

An outer electrode is provided on the bottom surface of the element body 10. The outer electrode may include the first outer electrode E1, the second outer electrode E2, the third outer electrode E3, and the fourth outer electrode E4. The first outer electrode E1 and the second outer electrode E2 may be electrically connected to the first winding portion W1. In addition, the third outer electrode E3 and the fourth outer electrode E4 may be electrically connected to the second winding portion W2. When the outer electrode is provided on the bottom surface (the first main surface 11) of the element body 10, the multilayer inductor 1A can be appropriately mounted on a mounting substrate or the like.

The first outer electrode E1 may be provided only on the first main surface 11 of the element body 10, but may be provided so as to extend over the first main surface 11 and the first end surface 13 and/or the first side surface 15 of the element body 10.

The second outer electrode E2 may be provided only on the first main surface 11 of the element body 10, but may be provided so as to extend over the first main surface 11 and the first end surface 13 and/or the second side surface 16 of the element body 10.

The third outer electrode E3 may be provided only on the first main surface 11 of the element body 10, but may be provided so as to extend over the first main surface 11 and the second end surface 14 and/or the second side surface 16 of the element body 10.

The fourth outer electrode E4 may be provided only on the first main surface 11 of the element body 10, but may be provided so as to extend over the first main surface 11 and the second end surface 14 and/or the first side surface 15 of the element body 10.

As a preferred aspect of the outer electrode, the plane areas of the outer electrodes viewed from the mounting surface side of the element body 10 may be made smaller than the plane areas of the first through-hole T1 to the fourth through-hole T4 of the stacking group G13. By making the plane areas of the outer electrodes smaller than those of the first through-hole T1 to the fourth through-hole T4 of the stacking group G13, the outer electrodes, for which accuracy of predetermined positions on the element body are required, and the through-holes, whose positions are deviated due to shrinkage by firing, can be easily connected to each other.

For the outer electrode, various materials such as Cu and/or Au can be used. The outer electrode may be formed by any method, but the outer electrode may be a plating electrode formed by, for example, a plating method (such as an electroless plating method and a sputtering method). After the outer electrode is formed, a plating method may be further used to form a plating layer of Ni, Sn, or the like on the outer electrode so as to form a multilayer structure of two or more layers.

### —First Coil—

The first coil C1 is provided inside the element body 10. The first coil C1 may include a plurality of parts of the first winding portion W1 connected to each other by the via-holes V, the first through-hole T1, the second through-hole T2, the first connecting portion J1 that connects the one end of the first winding portion W1 and the first through-hole T1, and the second connecting portion J2 that connects the other end of the first winding portion W1 and the second through-hole T2.

As described above, the plurality of parts of the first winding portion W1 are provided so as to extend over three stacking groups (the stacking groups G8, G10, and G12). As a result, the number of turns of the first coil C1 is 2.5 in a three-layer structure. In addition, each of the lengths of the via-holes V connecting the plurality of parts of the first winding portion W1 in the stacking direction may be shorter than the length of the first through-hole T1 or the length of the second through-hole T2.

As described above, the plurality of parts of the first winding portion W1 may include the avoiding portion A that avoids the fourth through-hole T4. By avoiding the fourth through-hole T4 by the avoiding portion A, the element area can be reduced compared to an aspect in which the avoiding portion is not provided.

In the first coil C1, the first through-hole T1 may electrically connect an end portion of the first winding portion W1 closest to the bottom surface (the first main surface 11) of the element body 10 to the first outer electrode E1. The first connecting portion J1 may be interposed between the one end of the first winding portion W1 and the first through-hole T1. The first through-hole T1 may extend in the stacking direction (for example, the height direction T). The first through-hole T1 may have a multilayer structure.

The second through-hole T2 may electrically connect the other end portion of the first coil C1 to the second outer electrode E2. The second connecting portion J2 may be interposed between the other end of the first winding portion W1 and the second through-hole T2. The second through-hole T2 may extend in the stacking direction (for example, the height direction T). The second through-hole T2 may have a multilayer structure.

### —Second Coil—

The second coil C2 is provided inside the element body 10 and above the first coil C1 in the stacking direction. The second coil C2 may include a plurality of parts of the second winding portion W2 connected to each other by the via-holes V, the third through-hole T3, the fourth through-hole T4, the third connecting portion J3 that connects the one end of the second winding portion W2 and the third through-hole T3, and the fourth connecting portion J4 that connects the other end of the second winding portion W2 and the fourth through-hole T4.

As described above, the plurality of parts of the second winding portion W2 are provided so as to extend over three stacking groups (the stacking groups G2, G4, and G6). As a result, the number of turns of the second coil C2 is 2.5 in a three-layer structure. In addition, each of the lengths of the via-holes V connecting the plurality of parts of the second winding portion W2 in the stacking direction may be shorter than the length of the third through-hole T3 or the length of the fourth through-hole T4.

As described above, the plurality of parts of the second winding portion W2, except the part of the second winding portion W2 electrically connected to the fourth through-hole T4, may include the avoiding portion A that avoids the fourth through-hole T4. By avoiding the fourth through-hole T4 by the avoiding portion A, the element area can be reduced compared to an aspect in which the avoiding portion is not provided.

In the second coil C2, the third through-hole T3 may electrically connect an end portion of the second winding portion W2 closest to the bottom surface (the first main surface 11) of the element body 10 to the third outer electrode E3. The third connecting portion J3 may be interposed between the one end of the second winding portion W2 and the third through-hole T3. The third through-hole T3 may extend in the stacking direction (for example, the height direction T). The third through-hole T3 may have a multilayer structure.

The fourth through-hole T4 may electrically connect the other end portion of the second coil C2 to the fourth outer electrode E4. The fourth connecting portion J4 may be interposed between the other end of the second winding portion W2 and the fourth through-hole T4. The fourth through-hole T4 may extend in the stacking direction (for example, the height direction T). The fourth through-hole T4 may have a multilayer structure.

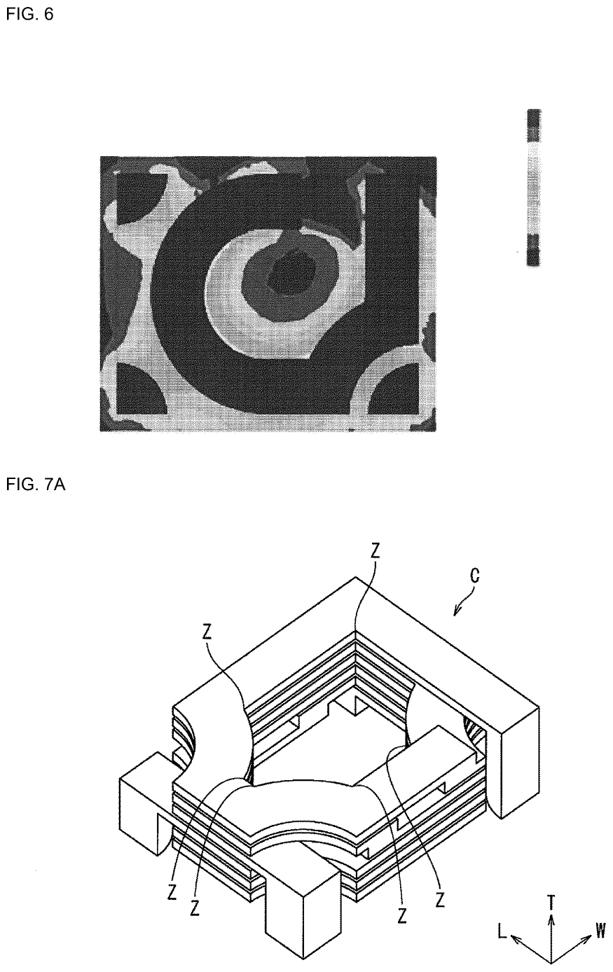

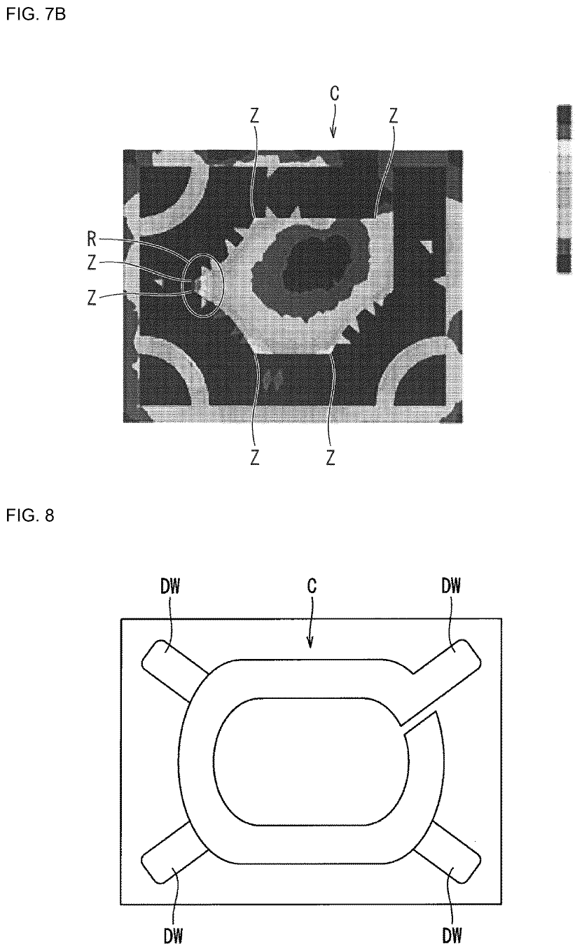

As described above, the multilayer inductor 1A includes the element body 10, the first outer electrode E1 to the fourth outer electrode E4, the first coil C1 including the first winding portion W1, the second coil C2 including the second winding portion W2, and the first through-hole T1 to the fourth through-hole T4. Since the first winding portion W1 and the second winding portion W2 have an elliptical shape in top view, compared to the multilayer inductor in the related art (see FIG. 7), the avoiding portion is reduced, and the number of the corner portions of the multilayer inductor is reduced, thereby being able to reduce magnetic saturation. Therefore, the direct current superposition characteristics of the multilayer inductor can be further improved. In addition, since the first winding portion W1 and/or the second winding portion W2 is provided with the avoiding portion A that avoids any one of the first through-hole T1 to the fourth through-hole T4, the element area can be further reduced compared to a multilayer inductor not provided with the avoiding portion and including a coil having a perfectly elliptical shape.

### Additional Configuration of Multilayer Inductor

As a preferred configuration of the multilayer inductor 1A, the length of a through-hole in the stacking direction has a relationship of the length of the fourth through-hole T4>the length of the third through-hole T3>the length of the second through-hole T2>the length of the first through-hole T1, and the avoiding portion A may avoid the fourth through-hole T4. Specifically, the avoiding portion A may avoid the fourth through-hole T4 which is set to be the longest. In addition, the avoiding portion A may be provided in the parts of the second winding portion W2 of the stacking groups G4 and G6 and the parts of the first winding portion W1 of the stacking groups G8, G10, and G12, except the part of the second winding portion W2 of the stacking group G2. According to such a configuration, the avoiding portion A can be provided in most parts of the first winding portion W1 and the second winding portion W2, and the element area can be made further smaller by the avoiding portion A.

In addition to including the avoiding portion A that avoids any one of the first through-hole T1 to the fourth through-hole T4 in the first winding portion W1 and/or the second winding portion W2, the winding axis P of the first winding portion W1 and/or the winding axis P of the second winding portion W2 may be deviated from the center O of the element body 10 in top view. According to the above-described configuration, a wiring line that extends outside the first winding portion W1 and/or the second winding portion W2 can be reduced, and the element area can be further reduced.

In addition, a direction in which the winding axis P described above is deviated may be a side on which the avoiding portion A is provided in top view. For example, in the example illustrated in FIG. 3, the winding axis P may be deviated toward the side on which the avoiding portion A is provided (a +W direction side). According to such a configuration, a wiring line that extends outside the avoiding portion A of the first winding portion W1 and/or the second winding portion W2 can be further reduced, and the element area can be further reduced.

As a preferred configuration of the multilayer inductor 1A, the one end of the first winding portion W1 and the first through-hole T1 may be connected with the linear first connecting portion J1 interposed therebetween, the other end of the first winding portion W1 and the second through-hole T2 may be connected with the curved second connecting portion J2 interposed therebetween, the one end of the second winding portion W2 and the third through-hole T3 may be connected with the curved third connecting portion J3 interposed therebetween, and the other end of the second winding portion W2 and the fourth through-hole T4 may be connected with the linear fourth connecting portion J4 interposed therebetween. For example, in the example illustrated in FIGS. 2 and 3, the connecting portions (the second connecting portion J2 and the third connecting portion J3) on a −W direction side are curved in top view, and the connecting portions (the first connecting portion J1 and the fourth connecting portion J4) on the +W direction side are linear in top view. Therefore, as described above, the winding axes P of the first winding portion W1 and the second winding portion W2 can be appropriately deviated from the center O of the element body in top view. Moreover, since the connecting portions on the +W direction side are linear in top view, a wiring line that extends outside the avoiding portion A of the first winding portion W1 and the second winding portion W2 can be reduced, and the element area can be further reduced.

In addition, in the curved second connecting portion J2 and the curved third connecting portion J3 described above, the curvatures of the second connecting portion J2 and the third connecting portion J3 may be smaller than the curvatures of the first winding portion W1 and the second winding portion W2. By making the curvatures of the second connecting portion J2 and the third connecting portion J3 as small as possible (making the curves gentle), the inner diameters of the first winding portion W1 and the second winding portion W2 can be made as large as possible, and thus the characteristics of inductance can be improved

The second outer electrode E2 and the third outer electrode E3 may be disposed along one side of the bottom surface of the element body having a rectangular shape. With this configuration, disposing the second outer electrode E2 and the third outer electrode E3 on a diagonal line is excluded, and the second through-hole T2 and the other end of the first winding portion W1 electrically connected to the second outer electrode E2, and the third through-hole T3 and the one end of the second winding portion W2 electrically connected to the third outer electrode E3 are appropriately disposed, and thus the element area can be further reduced.

### Multilayer Inductor Array

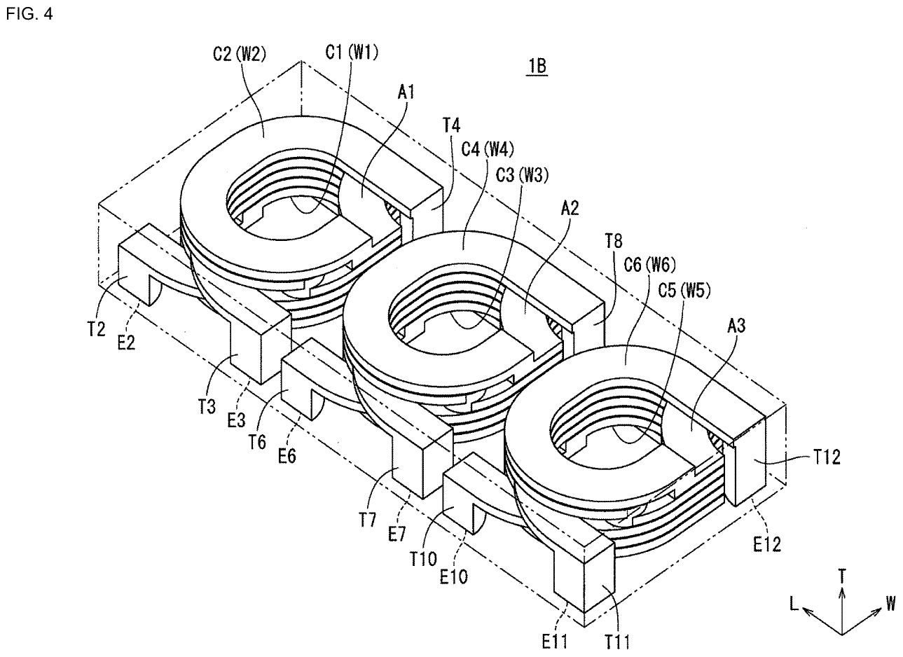

Next, a multilayer inductor array of the present disclosure will be described with reference to FIG. 4. FIG. 4 is a perspective view schematically illustrating an example of the multilayer inductor array of the present disclosure.

A multilayer inductor array 1B of the present disclosure configures a coil array by arranging three first coils and three second coils side by side in a direction intersecting the stacking direction. Specifically, in addition to the first winding portion W1 and the second winding portion W2, a third winding portion W3 and a fourth winding portion W4, and a fifth winding portion W5 and a sixth winding portion W6 configured by winding a conductor layer may be included.

The third winding portion W3 and the fifth winding portion W5 may be disposed so as to be aligned with the first winding portion W1 in a direction intersecting the stacking direction. In addition, the fourth winding portion W4 and the sixth winding portion W6 may be disposed so as to be aligned with the second winding portion W2 in a direction intersecting the stacking direction. The third winding portion W3, the fifth winding portion W5, and the first winding portion W1 have substantially the same structure, and the fourth winding portion W4, the sixth winding portion W6, and the second winding portion W2 have substantially the same structure.

The third winding portion W3 may be electrically connected to a fifth outer electrode (not illustrated) and a sixth outer electrode E6. Specifically, an end portion of the third winding portion W3 closest to the bottom surface and the fifth outer electrode may be electrically connected by a fifth through-hole (not illustrated). In addition, the other end portion of the third winding portion W3 and the sixth outer electrode E6 may be connected by a sixth through-hole T6.

The fourth winding portion W4 may be electrically connected to a seventh outer electrode E7 and an eighth outer electrode (not illustrated). Specifically, an end portion of the fourth winding portion W4 closest to the bottom surface and the seventh outer electrode E7 may be connected by a seventh through-hole T7. In addition, the other end portion of the fourth winding portion W4 and the eighth outer electrode may be connected by an eighth through-hole T8.

The fifth winding portion W5 may be electrically connected to a ninth outer electrode (not illustrated) and a tenth outer electrode E10. Specifically, an end portion of the fifth winding portion W5 closest to the bottom surface and the ninth outer electrode may be connected by a ninth through-hole (not illustrated). In addition, the other end portion of the fifth winding portion W5 and the tenth outer electrode E10 may be connected by a tenth through-hole T10.

The sixth winding portion W6 may be electrically connected to an eleventh outer electrode E11 and a twelfth outer electrode E12. Specifically, the end portion of the sixth winding portion W6 closest to the bottom surface and the eleventh outer electrode E11 may be connected by an eleventh through-hole T11. In addition, the other end portion of the sixth winding portion W6 and the twelfth outer electrode E12 may be connected by a twelfth through-hole T12.

In the multilayer inductor array of the present disclosure, the first winding portion W1 to the sixth winding portion W6 have an elliptical shape in top view, the first winding portion W1 and/or the second winding portion W2 includes a first avoiding portion A1 that avoids any one of the first through-hole T1 to the fourth through-hole T4, the third winding portion W3 and/or the fourth winding portion W4 includes a second avoiding portion A2 that avoids any one of the fifth through-hole to the eighth through-hole T8, and the fifth winding portion W5 and/or the sixth winding portion W6 includes a third avoiding portion A3 that avoids any one of the ninth through-hole to the twelfth through-hole T12. Specifically, as illustrated in FIG. 4, the first avoiding portion A1 avoids the fourth through-hole T4, the second avoiding portion A2 avoids the eighth through-hole T8, and the third avoiding portion A3 avoids the twelfth through-hole T12.

According to the multilayer inductor array 1B of the present disclosure, since the first winding portion W1 to the fourth winding portion W4 have an elliptical shape in top view, similarly to the multilayer inductor 1A of the present disclosure, magnetic saturation can be reduced, and the direct current superposition characteristics can be further improved. In addition, since the first avoiding portion A1, the second avoiding portion A2, and the third avoiding portion A3 are provided, similarly to the multilayer inductor 1A of the present disclosure, the element area can be further reduced.

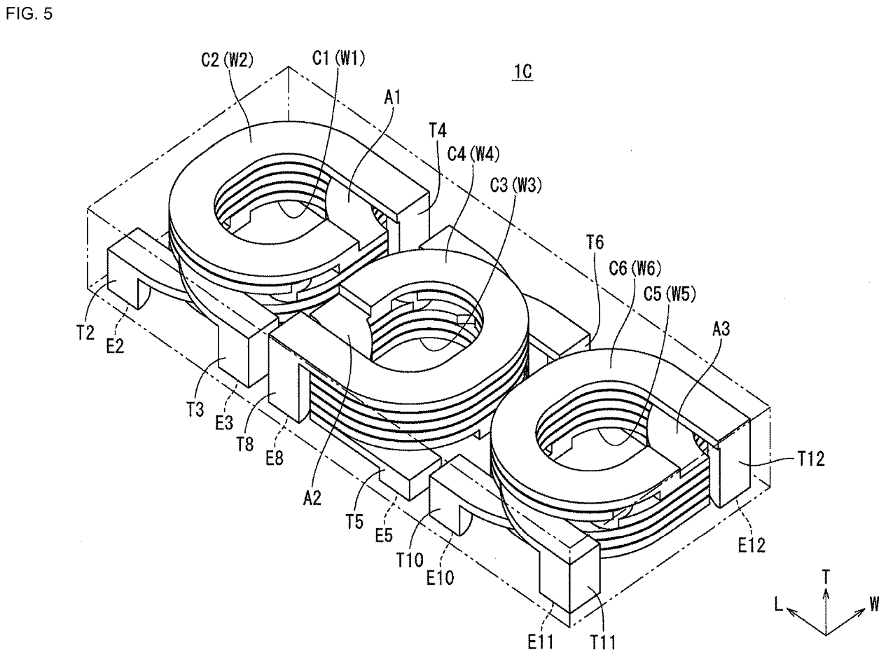

Next, a modification of the multilayer inductor array of the present disclosure will be described with reference to FIG. 5. FIG. 5 is a perspective view schematically illustrating a modification of the multilayer inductor array of the present disclosure. The modification is different from the multilayer inductor array described above in a positional relationship between the first avoiding portion A1 and the third avoiding portion A3, and the second avoiding portion A2. Other configurations are as described as the above-described multilayer inductor array.

In a multilayer inductor array 1C of the present modification, as illustrated in FIG. 5, the second avoiding portion A2 is not disposed along the same one side of the element body 10 as the first avoiding portion A1 and the third avoiding portion. Specifically, the first avoiding portion A1 and the third avoiding portion may be disposed on the +W direction side of the element body 10, and the second avoiding portion A2 may be rotated at 180 ° and disposed on the −W direction side of the element body 10 (that is, the first avoiding portion A1 and the second avoiding portion A2 may be alternately disposed). According to such a configuration, in the first winding portion W1 and the fifth winding portion W5 adjacent to the third winding portion W3, and the second winding portion W2 and the sixth winding portion W6 adjacent to the fourth winding portion W4, directions of magnetic fluxes become opposite, deflection of the magnetic fluxes is reduced, and magnetic saturation is further unlikely to occur. Therefore, the direct current superposition characteristics of the multilayer inductor can be improved.

The multilayer inductor arrays 1B and 1C described above have been described in a shape in which each of the arrays includes three multilayer inductors 1A, but may include two multilayer inductors 1A or four or more multilayer inductors 1A EXAMPLES Hereinafter, demonstration experiments regarding the multilayer inductor of the present disclosure have been performed.

<demonstration Experiment 1 (magnetic Field Analysis Simulation)>

In Demonstration Experiment 1, simulation models of Example 1, which is the multilayer inductor of the present disclosure described below, and Comparative Example 1, which is the multilayer inductor in the related art, have been prepared, and magnetic field analysis simulation has been performed.

EXAMPLE 1 As illustrated in FIG. 2, in the multilayer inductor, the first winding portion W1 and the second winding portion W2 have an elliptical shape in top view, and the first winding portion W1 and the second winding portion W2 include the avoiding portion A that avoids the fourth through-hole T4 and are provided with two corner portions Z (see FIG. 6).

A more specific parameter is as described below.

A size of the element body 10 (see FIG. 2): L direction: 1.6 mm×W direction: 2.0 mm×T direction: 1.0 mm A width d (see FIG. 2) of the first winding portion (or the second winding portion) in top view: 0.38 mm

A height of the first winding portion (or the second winding portion) (heights (thicknesses) of the first and second winding portions W1 and W2 in each stacking group in FIG. 3): 0.085 mm

A gap between layers of the first winding portion (or the second winding portion) (an interval between stacking groups in the respective stacking groups in FIG. 3): 0.01 mm The number of turns of the first winding portion (or the second winding portion): 2.5

### Comparative Example 1

As illustrated in FIG. 7A, in the multilayer inductor, the first winding portion and the second winding portion have a substantially rectangular shape in top view, the first winding portion and the second winding portion include an avoiding portion that avoids the second through-hole, an avoiding portion that avoids the third through-hole, and an avoiding portion that avoids the fourth through-hole and are provided with the corner portions Z at five locations (see FIG. 7A).

For the magnetic field analysis simulation, Femtet (registered trademark) manufactured by Murata Software Co., Ltd. was used.

FIG. 7B illustrates a result of the magnetic field analysis simulation performed on the multilayer inductor of Comparative Example 1. According to FIG. 7B, a result in which magnetic saturation occurs in a region R where the magnetic flux is concentrated in the corner portions Z has been obtained. On the other hand, FIG. 6 illustrates a result of the magnetic field analysis simulation performed on the multilayer inductor of Example 1. According to FIG. 6, a result in which, compared to FIG. 7B, the number of the corner portions is reduced and magnetic saturation is reduced has been obtained.

### Demonstration Experiment 2 (Direct Current Superposition Current Simulation)

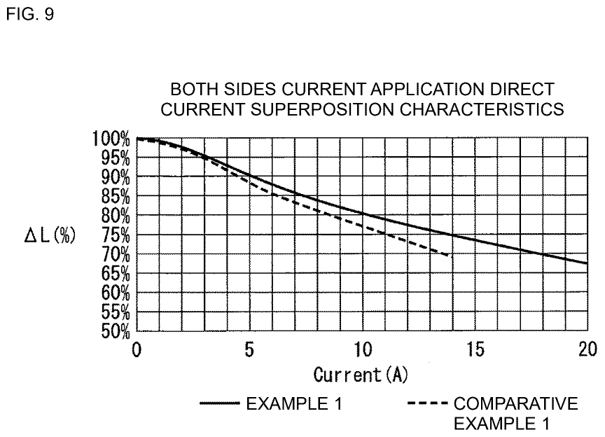

Next, from the simulation results of Example 1 and Comparative Example 1 described above, direct current superposition currents have been obtained. FIG. 9 is a graph illustrating simulation results of the direct current superposition characteristics of Example 1 and Comparative Example 1.

From the results of FIG. 9, the direct current superposition current of the multilayer inductor of Example 1 is 17.5 A whereas the direct current superposition current of the multilayer inductor of Comparative Example 1 is 14 A. From these results, a result showing that the direct current superposition current of the multilayer inductor of Example 1 is higher has been obtained.

It should be noted that embodiments disclosed herein are by way of illustration in all aspects and not a basis for a restrictive interpretation. Therefore, the technical scope of the present disclosure is not construed only by the above-described embodiments, but defined based on the recitation of claims and includes all modifications equivalent in meaning and scope to the claims.

The multilayer inductor and the multilayer inductor array of the present disclosure include the following aspects.

<1> A multilayer inductor including an element body in which magnetic layers are stacked in a stacking direction and that has a bottom surface having a rectangular shape; a first outer electrode, a second outer electrode, a third outer electrode, and a fourth outer electrode provided at four corners of the bottom surface of the element body; a first winding portion in which a plurality of conductor layers disposed in the element body are connected in a stacking direction and that has a winding axis in the stacking direction; a second winding portion that is located above the first winding portion in the stacking direction, in which a plurality of conductor layers disposed in the element body are connected in the stacking direction, and that has a winding axis in the stacking direction; a first through-hole that electrically connects one end of the first winding portion to the first outer electrode and extends in the stacking direction; a second through-hole that electrically connects an other end of the first winding portion to the second outer electrode and extends in the stacking direction; a third through-hole that electrically connects one end of the second winding portion to the third outer electrode and extends in the stacking direction; and a fourth through-hole that electrically connects an other end of the second winding portion to the fourth outer electrode and extends in the stacking direction. The first winding portion and the second winding portion have an elliptical shape in top view, and the first winding portion and/or the second winding portion includes an avoiding portion that avoids any one of the first through-hole to the fourth through-hole. <2> The multilayer inductor according to <1>, in which a length of a through-hole in the stacking direction satisfies relationships below: a length of the fourth through-hole>a length of the third through-hole, the length of the third through-hole>a length of the second through-hole, and the length of the second through-hole>a length of the first through-hole. Also, the avoiding portion avoids the fourth through-hole.

<3> The multilayer inductor according to <1>or <2>, in which the winding axis of the first winding portion and the winding axis of the second winding portion are deviated from a center of the element body in a direction intersecting the stacking direction.

<4> The multilayer inductor according to <3>, in which the direction in which the winding axes are deviated is on a side on which the avoiding portion is provided in a direction intersecting the stacking direction in top view.

<5> The multilayer inductor according to any one of <1>to <4>, in which the one end of the first winding portion and the first through-hole are connected with interposition of a first connecting portion having a linear shape, the other end of the first winding portion and the second through-hole are connected with interposition of a second connecting portion having a curved shape, the one end of the second winding portion and the third through-hole are connected with interposition of a third connecting portion having a curved shape, and the other end of the second winding portion and the fourth through-hole are connected with interposition of a fourth connecting portion having a linear shape.

<6> The multilayer inductor according to <5>, in which curvatures of the second connecting portion and the third connecting portion are smaller than curvatures of the first winding portion and the second winding portion.

<7> The multilayer inductor according to any one of <1>to <6>, in which the second outer electrode and the third outer electrode are disposed along one side of the bottom surface of the element body having a rectangular shape.

<8> A multilayer inductor array including an element body in which magnetic layers are stacked in a stacking direction and that has a bottom surface having a rectangular shape; a first outer electrode, a second outer electrode, a third outer electrode, a fourth outer electrode, a fifth outer electrode, a sixth outer electrode, a seventh outer electrode, and an eighth outer electrode provided along four sides of the bottom surface of the element body; a first winding portion in which a plurality of conductor layers are connected in the stacking direction and that has a winding axis in the stacking direction; a second winding portion that is located above the first winding portion in the stacking direction, in which a plurality of conductor layers are connected in the stacking direction, and that has a winding axis in the stacking direction; a third winding portion in which a plurality of conductor layers are connected in the stacking direction and that has a winding axis in the stacking direction; and a fourth winding portion that is located above the third winding portion in the stacking direction, in which a plurality of conductor layers are connected in the stacking direction, and that has a winding axis in the stacking direction. The multilayer inductor array further includes a first through-hole that electrically connects one end of the first winding portion to the first outer electrode and extends in the stacking direction; a second through-hole that electrically connects an other end of the first winding portion to the second outer electrode and extends in the stacking direction; a third through-hole that electrically connects one end of the second winding portion to the third outer electrode and extends in the stacking direction; a fourth through-hole that electrically connects an other end of the second winding portion to the fourth outer electrode and extends in the stacking direction; a fifth through-hole that electrically connects one end of the third winding portion to the fifth outer electrode and extends in the stacking direction; a sixth through-hole that electrically connects an other end of the third winding portion to the sixth outer electrode and extends in the stacking direction; a seventh through-hole that electrically connects one end of the fourth winding portion to the seventh outer electrode and extends in the stacking direction; and an eighth through-hole that electrically connects an other end of the fourth winding portion to the eighth outer electrode and extends in the stacking direction. The third winding portion is disposed in a direction intersecting the stacking direction with respect to the first winding portion, the fourth winding portion is disposed in the direction intersecting the stacking direction with respect to the second winding portion, the first winding portion, the second winding portion, the third winding portion, and the fourth winding portion have an elliptical shape in top view, the first winding portion and/or the second winding portion includes a first avoiding portion that avoids any one of the first through-hole to the fourth through-hole, and the third winding portion and/or the fourth winding portion includes a second avoiding portion that avoids any one of the fifth through-hole to the eighth through-hole.

<9> The multilayer inductor array according to <8>, in which the first avoiding portion and the second avoiding portion are not disposed along one side of the element body.

<10> The multilayer inductor array according to <8>or <9>, in which the first winding portion and the third winding portion and/or the second winding portion and the fourth winding portion adjacent to each other in the direction intersecting the stacking direction are alternately disposed.

### INDUSTRIAL APPLICABILITY

The present disclosure can be used for a multilayer inductor and a multilayer inductor array in which the element area is reduced and the direct current superposition characteristics are further improved.

What is claimed is:

1. A multilayer inductor comprising:
an element body in which magnetic layers are stacked in a stacking direction and that has a bottom surface having a rectangular shape;
a first outer electrode, a second outer electrode, a third outer electrode, and a fourth outer electrode at four corners of the bottom surface of the element body;
a first winding portion in which a plurality of conductor layers in the element body are connected in a stacking direction and that has a winding axis in the stacking direction;
a second winding portion that is above the first winding portion in the stacking direction, in which a plurality of conductor layers in the element body are connected in the stacking direction, and that has a winding axis in the stacking direction;
a first through-hole that electrically connects one end of the first winding portion to the first outer electrode and extends in the stacking direction;
a second through-hole that electrically connects an other end of the first winding portion to the second outer electrode and extends in the stacking direction;
a third through-hole that electrically connects one end of the second winding portion to the third outer electrode and extends in the stacking direction; and
a fourth through-hole that electrically connects an other end of the second winding portion to the fourth outer electrode and extends in the stacking direction, wherein the first winding portion and the second winding portion have an elliptical shape in top view, and
at least one of the first winding portion or the second winding portion includes an avoiding portion that avoids any one of the first through-hole to the fourth through-hole.

2. The multilayer inductor according to claim 1, wherein a length of a through-hole in the stacking direction satisfies relationships below:
a length of the fourth through-hole>a length of the third through-hole,
the length of the third through-hole>a length of the second through-hole, and
the length of the second through-hole>a length of the first through-hole, and
the avoiding portion avoids the fourth through-hole.

3. The multilayer inductor according to claim 1, wherein
the winding axis of the first winding portion and the winding axis of the second winding portion are deviated from a center of the element body in a direction intersecting the stacking direction.

4. The multilayer inductor according to claim 3, wherein
the direction in which the winding axes are deviated is on a side on which the avoiding portion is provided in a direction intersecting the stacking direction in top view.

5. The multilayer inductor according to claim 1, wherein
the one end of the first winding portion and the first through-hole are connected with interposition of a first connecting portion having a linear shape,
the other end of the first winding portion and the second through-hole are connected with interposition of a second connecting portion having a curved shape,
the one end of the second winding portion and the third through-hole are connected with interposition of a third connecting portion having a curved shape, and
the other end of the second winding portion and the fourth through-hole are connected with interposition of a fourth connecting portion having a linear shape.

6. The multilayer inductor according to claim 5, wherein
curvatures of the second connecting portion and the third connecting portion are smaller than curvatures of the first winding portion and the second winding portion.

7. The multilayer inductor according to claim 1, wherein
the second outer electrode and the third outer electrode are disposed along one side of the bottom surface of the element body having a rectangular shape.

8. The multilayer inductor according to claim 2, wherein
the winding axis of the first winding portion and the winding axis of the second winding portion are deviated from a center of the element body in a direction intersecting the stacking direction.

9. The multilayer inductor according to claim 2, wherein
the one end of the first winding portion and the first through-hole are connected with interposition of a first connecting portion having a linear shape,
the other end of the first winding portion and the second through-hole are connected with interposition of a second connecting portion having a curved shape,
the one end of the second winding portion and the third through-hole are connected with interposition of a third connecting portion having a curved shape, and
the other end of the second winding portion and the fourth through-hole are connected with interposition of a fourth connecting portion having a linear shape.

10. The multilayer inductor according to claim 3, wherein
the one end of the first winding portion and the first through-hole are connected with interposition of a first connecting portion having a linear shape,
the other end of the first winding portion and the second through-hole are connected with interposition of a second connecting portion having a curved shape,
the one end of the second winding portion and the third through-hole are connected with interposition of a third connecting portion having a curved shape, and
the other end of the second winding portion and the fourth through-hole are connected with interposition of a fourth connecting portion having a linear shape.

11. The multilayer inductor according to claim 4, wherein
the one end of the first winding portion and the first through-hole are connected with interposition of a first connecting portion having a linear shape,
the other end of the first winding portion and the second through-hole are connected with interposition of a second connecting portion having a curved shape,
the one end of the second winding portion and the third through-hole are connected with interposition of a third connecting portion having a curved shape, and
the other end of the second winding portion and the fourth through-hole are connected with interposition of a fourth connecting portion having a linear shape.

12. The multilayer inductor according to claim 2, wherein
the second outer electrode and the third outer electrode are disposed along one side of the bottom surface of the element body having a rectangular shape.

13. The multilayer inductor according to claim 3, wherein
the second outer electrode and the third outer electrode are disposed along one side of the bottom surface of the element body having a rectangular shape.

14. The multilayer inductor according to claim 4, wherein
the second outer electrode and the third outer electrode are disposed along one side of the bottom surface of the element body having a rectangular shape.

15. The multilayer inductor according to claim 5, wherein
the second outer electrode and the third outer electrode are disposed along one side of the bottom surface of the element body having a rectangular shape.

16. The multilayer inductor according to claim 6, wherein
the second outer electrode and the third outer electrode are disposed along one side of the bottom surface of the element body having a rectangular shape.

17. A multilayer inductor array comprising:
an element body in which magnetic layers are stacked and that has a bottom surface having a rectangular shape;
a first outer electrode, a second outer electrode, a third outer electrode, a fourth outer electrode, a fifth outer electrode, a sixth outer electrode, a seventh outer electrode, and an eighth outer electrode provided along four sides of the bottom surface of the element body;
a first winding portion in which a plurality of conductor layers in the element body are connected in a stacking direction and that has a winding axis in the stacking direction;
a second winding portion that is above the first winding portion in the stacking direction, in which a plurality of conductor layers in the element body are connected in the stacking direction, and that has a winding axis in the stacking direction;
a third winding portion in which a plurality of conductor layers are connected in the stacking direction and that has a winding axis in the stacking direction;
a fourth winding portion that is above the third winding portion in the stacking direction, in which a plurality of conductor layers are connected in the stacking direction, and that has a winding axis in the stacking direction;
a first through-hole that electrically connects one end of the first winding portion to the first outer electrode and extends in the stacking direction;
a second through-hole that electrically connects an other end of the first winding portion to the second outer electrode and extends in the stacking direction;
a third through-hole that electrically connects one end of the second winding portion to the third outer electrode and extends in the stacking direction;
a fourth through-hole that electrically connects an other end of the second winding portion to the fourth outer electrode and extends in the stacking direction;
a fifth through-hole that electrically connects one end of the third winding portion to the fifth outer electrode and extends in the stacking direction;
a sixth through-hole that electrically connects an other end of the third winding portion to the sixth outer electrode and extends in the stacking direction;
a seventh through-hole that electrically connects one end of the fourth winding portion to the seventh outer electrode and extends in the stacking direction; and
an eighth through-hole that electrically connects an other end of the fourth winding portion to the eighth outer electrode and extends in the stacking direction, wherein the third winding portion is in a direction intersecting the stacking direction with respect to the first winding portion,
the fourth winding portion is in the direction intersecting the stacking direction with respect to the second winding portion,
the first winding portion, the second winding portion, the third winding portion, and the fourth winding portion have an elliptical shape in top view,
at least one of the first winding portion or the second winding portion includes a first avoiding portion that avoids any one of the first through-hole to the fourth through-hole, and
at least one of the third winding portion or the fourth winding portion includes a second avoiding portion that avoids any one of the fifth through-hole to the eighth through-hole.

18. The multilayer inductor array according to claim 17, wherein
the first avoiding portion and the second avoiding portion are not disposed along one side of the element body.

19. The multilayer inductor array according to claim 17, wherein
the first winding portion and the third winding portion and/or the second winding portion and the fourth winding portion adjacent to each other in the direction intersecting the stacking direction are alternately disposed.

20. The multilayer inductor array according to claim 18, wherein
the first winding portion and the third winding portion and/or the second winding portion and the fourth winding portion adjacent to each other in the direction intersecting the stacking direction are alternately disposed.
